(19) United States
(12) Patent Application Publication
(10) Pub. No.: US 2016/0085091 A1
(43) Pub. Date: Mar. 24, 2016

(54) EYEGLASS FRAME STRUCTURE HAVING U-SHAPED WIND PASSAGE AND EYEGLASSES HAVING THE SAME

(71) Applicant: T-LINK PPE LTD., Taipei City (TW)

(72) Inventor: JUN-HAN CHU, Taipei City (TW)

(21) Appl. No.: 14/495,634

(22) Filed: Sep. 24, 2014

(51) Int. Cl. G02C 11/08; G02C 1/02

(52) U.S. Cl. CPC G02C 11/08; G02C 1/02

(57) ABSTRACT

An eyeglass frame structure includes a frame, an eyeglass arm pivoting portion disposed separately on both sides of the frame, a lens connecting portion disposed between the eyeglass arm pivoting portions, a U-shaped wind passage formed at each eyeglass arm pivoting portion and having a wind inlet on a windward side of the frame and a wind outlet on a leeward side of the frame for guiding wind transversely to the leeward side of the lens. Eyeglasses with the eyeglass frame structure including two eyeglass arms, two lenses and two nose pads guide wind transversely to the leeward side of the lens to prevent the formation of mists, return air from causing discomfort to wearer's eyes, and tiny objects from entering into the leeward side of the lens. The glasses require no hole or slot formed on the lens, so that the lens structure is not damaged.

### FIELD OF THE INVENTION

The present invention relates to an eyeglass frame structure and eyeglasses having the eyeglass frame structure, in particular to the eyeglass frame structure and eyeglasses having the eyeglass frame structure capable of guiding wind in a transverse direction to a leeward side of a lens to prevent producing mists or causing discomfort to a wearer's eyes by return wind, and the eyeglasses require no hole or slot on the lens to prevent damaging the structure of the lens.

### BACKGROUND OF THE INVENTION

People often wear glasses to assist their vision for looking at a far distance or a near distance, and during exercise or at work. In general, glasses are divided according to their function into nearsighted glasses, farsighted glasses, reading glasses, sunglasses, sports goggles, work goggles, etc.

In the sports and work goggles, mists are generally formed on the leeward side of the lens, which may hinder a wearer's vision, so some manufacturers drill a hole or form a slot on the lens to guide wind to the leeward side of the lens in order to reduce the formation of mists. However, the hole or slot formed on the lens generally reduces the structural strength of the lens and also causes a refraction of light from the lens. In addition, the hole or slot formed on the lens may invite tiny objects in the air to pass through and hurt the wearer's eyes. In addition, there is no guarantee that the hole or slot formed on the lens would guide the wind to land at the leeward side of the lens so that the formation of mists is reduced, and the wind generally flows from the top of the leeward side of the lens through the rear of the hole or slot, formed at the upper edge of the lens, downwards to the lower edge of the leeward side of the lens through a gap between a curved surface of the lens and a cheek bone of the wearer's face, having the return air blocked and distributed to the wearer's eyes that causes discomfort to the wearer.

Therefore, it is a main subject of the present invention to design and develop an eyeglass frame structure and eyeglasses having the eyeglass frame structure, so that wind is guided transversely to the leeward side of the lens to prevent the formation of mists, return air from causing discomfort to the wearer's eyes, and tiny objects from entering into the leeward side of the lens, the eyeglasses have no hole or slot formed on the lens, and thus the lens structure is not damaged.

### SUMMARY OF THE INVENTION

In view of the aforementioned drawbacks, the inventor of the present invention based on years of experience in the related industry to conduct extensive researches and experiments, and finally developed an eyeglass frame structure and a pair of eyeglasses with the same structure in accordance with the present invention to overcome the drawbacks of the prior art.

Therefore, it is a primary objective of the invention to provide an eyeglass frame structure and eyeglasses having the eyeglass frame structure, in hope of achieving the effects of guiding wind transversely to the leeward side of the lens to prevent the formation of mists, return air from causing discomfort to the wearer's eyes, and tiny objects from entering into the leeward side of the lens and having no hole or slot formed on the lens, so that the lens structure is not damaged.

To achieve the aforementioned and other objectives, the present invention provides an eyeglass frame structure of a first preferred embodiment, comprising: a frame, an eyeglass arm pivoting portion disposed separately on both left and right sides of the frame, a lens connecting portion disposed between the eyeglass arm pivoting portions of the frame, a U-shaped wind passage formed at each of the eyeglass arm pivoting portions and having a wind inlet formed at a windward side of the frame and a wind outlet formed at a leeward side of the frame, and the wind outlets being provided for guiding wind transversely to the leeward side of the lens.

In the eyeglass frame structure, the frame is substantially in U-shaped, and an outwardly convex side of the frame is the windward side, and an inwardly concave side of the frame is the leeward side, and the lens connecting portion is an embedded slot disposed at a lower edge of the frame for embedding into an upper edge of the lens.

In the eyeglass frame structure, the frame includes a snap hole interconnected to the lens connecting portion and provided for snapping to a snap member of the lens, or the frame includes a snap member disposed in the lens connecting portion for snapping to the snap hole of the lens.

In the eyeglass frame structure, the wind outlets are provided for installing and containing snap plates installed on both left and right sides of the lens respectively.

In the eyeglass frame structure, the left and right sides of the leeward side of the frame have at least one wind guide slot formed at the wind outlets.

In the eyeglass frame structure, each of the eyeglass arm pivoting portions has a pivot slot for pivotally coupling a pivot pin of the eyeglass arm, or each of the eyeglass arm pivoting portions has a pivot pin for pivotally coupling the eyeglass arm.

The present invention further provides a pair of eyeglasses in accordance with a second embodiment, and the glasses comprise: an eyeglass frame structure of the first embodiment; two eyeglass arms, respectively and pivotally coupled to the eyeglass arm pivoting portions; a lens, installed to each of the lens connecting portions; and two nose pads, installed to a leeward side of the lens or a leeward side of the frame.

In the foregoing glasses, the frame is substantially U-shaped, and an outwardly convex side of the frame is the windward side, and an inwardly concave side of the frame is the leeward side, and the lens connecting portion is an embedded slot formed at a lower edge of the frame for embedding into an upper edge of the lens.

In the foregoing glasses, the frame includes a snap hole interconnected to the lens connecting portion for snapping a snap member to the lens, or the frame includes a snap member installed in the lens connecting portion for snapping to a snap hole of the lens.

In the foregoing glasses, the wind outlets are provided for installing and containing snap plates installed on both left and right sides of the lens respectively.

In the foregoing glasses, each of the snap plates has a thin plate section.

In the foregoing glasses, the left and right sides of the leeward side of the frame have at least one wind guide slot formed at the wind outlets.

In the foregoing glasses, each of the eyeglass arm pivoting portions has a pivot slot for pivotally coupling a pivot pin of the eyeglass arm, or each of the eyeglass arm pivoting portions has a pivot pin for pivotally coupling a pivot slot of the eyeglass arm.

In the foregoing glasses, the nose pads are coupled by an elastic rod.

Therefore, the eyeglass frame structure and eyeglasses having the eyeglass frame structure of the present invention can guide wind transversely to the leeward side of the lens to prevent the formation of mists, return air from causing discomfort to the wearer's eyes, and tiny objects from entering into the leeward side of the lens, and has no hole or slot formed on the lens, so that the lens structure is not damaged.

### BRIEF DESCRIPTION OF THE DRAWINGS

FIG. 1 is a first exploded view of a preferred embodiment of the present invention;

FIG. 2 is a second exploded view of a preferred embodiment of the present invention;

FIG. 3 is a third exploded view of a preferred embodiment of the present invention;

FIG. 4 is a schematic view of an eyeglass arm pivoting portion of a preferred embodiment of the present invention;

FIG. 5 is a cross-sectional view of an eyeglass arm pivoting portion of a preferred embodiment of the present invention;

FIG. 6 is a first perspective view of a preferred embodiment of the present invention;

FIG. 7 is a second perspective view of a preferred embodiment of the present invention; and

FIG. 8 is a cross-sectional view of an eyeglass arm pivoting portion and a snap plate of a preferred embodiment of the present invention.

### DETAILED DESCRIPTION OF THE PREFERRED EMBODIMENTS

The objects, characteristics and effects of the present invention will become apparent with the detailed description of the preferred embodiments and the illustration of related drawings as follows.

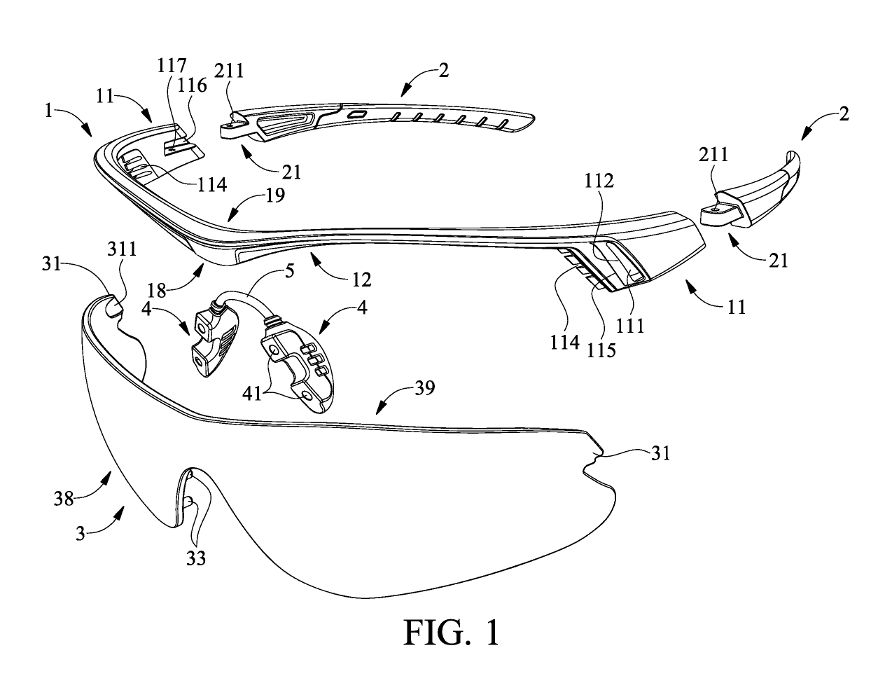

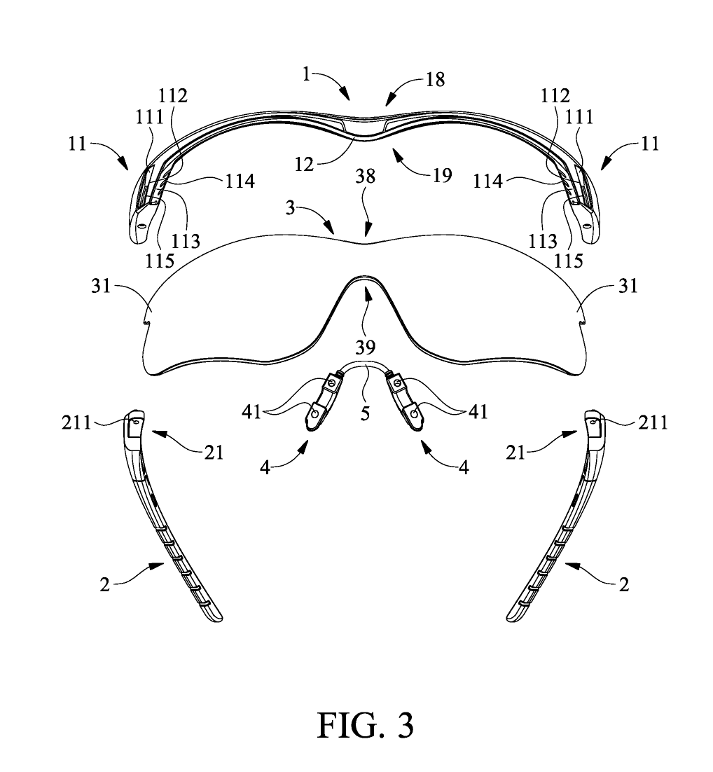

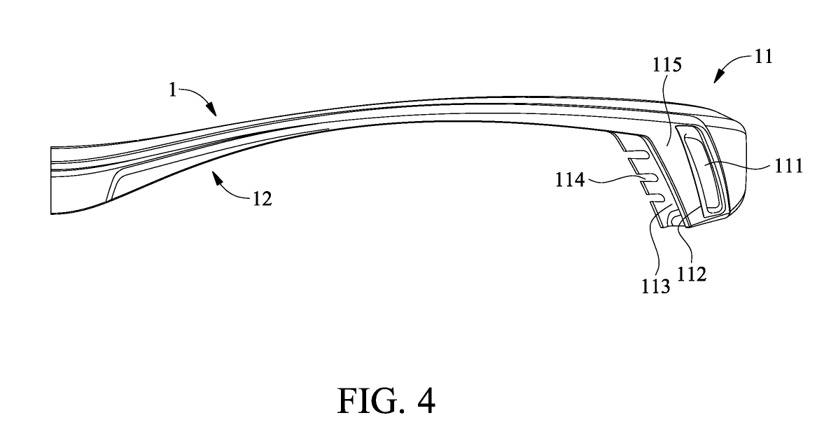

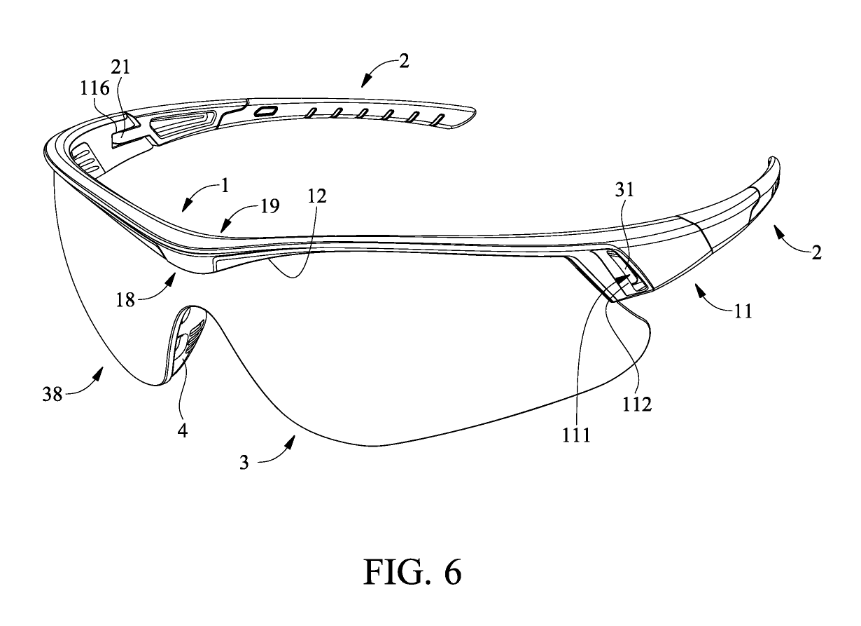

With reference to FIGS. 1 to 8 for an eyeglass frame structure in accordance with a first embodiment of the present invention, the eyeglass frame structure comprises: a frame 1 made of plastic or metal, and having an eyeglass arm pivoting portion 11 disposed separately on both left and right sides of the frame 1 for pivotally coupling an eyeglass arm 2, and a lens connecting portion 12 disposed between the eyeglass arm pivoting portions 11 for coupling a lens 3, wherein the lens 3 may be in any shape and made of plastic or glass, and the lens 3 comes with a parameter or a light filtering function, and each of the eyeglass arm pivoting portions 11 includes a U-shaped wind passage 111, and each of the U-shaped wind passages 111 has a wind inlet 112 formed on a windward side 18 of the frame 1 and a wind outlet 113 formed on a leeward side 19 of the frame 1, and a partition plate 115 is formed between the wind inlet 112 and the wind outlet 113, and the wind outlets 113 are provided for guiding wind transversely to the leeward side 39 of the lens 3, so that the wind flows transversely through the leeward side 39 of the lens 3.

As described above, the eyeglass frame structure of the present invention requires no hole or slot formed on the lens, so that the lens structure is not damaged, and no refraction occurs at the lens. In addition, the eyeglass frame structure of the present invention comes with a U-shaped wind passage for inhibiting tiny objects in the air from entering the leeward side of the lens directly, so as to protect the wearer's eyes from being damaged by the tiny objects. In addition, the wind outlet of the U-shaped wind passage of the eyeglass frame structure of the present invention guides wind transversely to the leeward side of the lens, so that the wind flows smoothly along the leeward side of the lens to dissipate heat and prevent the formation of mists. Since the eyeglass frame structure of the present invention drives the wind to flow transversely through the leeward side of the lens rather than flowing through a gap between a curved surface at the lower edge of the leeward side of the lens and a wearer's check bone, so as to further prevent blocking or distributing the return air that causes discomfort to the wearer's eyes.

With reference to FIGS. 1 to 3 for the eyeglass frame structure of the present invention, the frame 1 is substantially U-shaped, and an outwardly convex side of the frame 1 is a windward side 18, and an inwardly concave side of the frame 1 is a leeward side 19, and the lens connecting portion 12 is an embedded slot disposed at the lower edge of the frame 1 for embedding into the upper edge of the lens 3, and the wind outlet 113 of the eyeglass arm pivoting portions 11 is formed separately on both left and right sides of the lens 3. Therefore, the lens 3 of the present invention can be installed to the frame 1 easily, and drives the wind to flow from the left and right sides of the lens 3 transversely through the leeward side 39 of the lens 3.

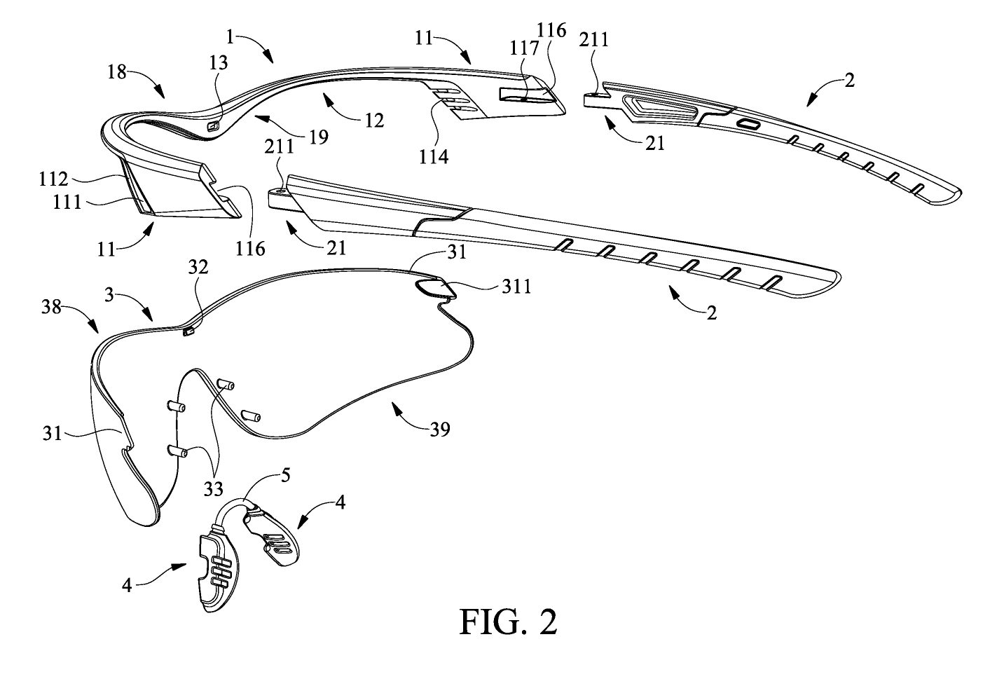

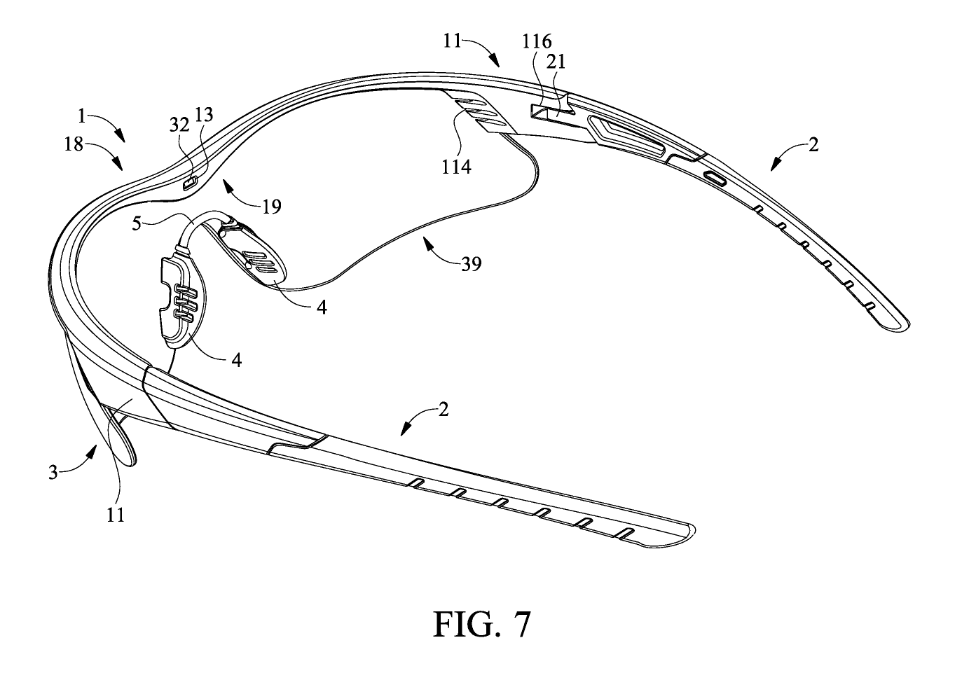

In the eyeglass frame structure as shown in FIGS. 2 and 7, a snap hole 13 is formed at the middle of the leeward side 19 of the frame 1 and interconnected to the lens connecting portion 12 for snapping to a snap member 32 disposed at the middle of the leeward side 39 of the lens 3 (or snapping a snap member installed at the middle of the leeward side 19 of the frame 1 and in the lens connecting portion 12 into a snap hole formed at the middle of the leeward side 39 of the lens 3), and the quantity and installation position of the snap holes 13 and the snap members 32 may be increased as required. Therefore, the lenses 3 may be installed to the frame 1 of the present invention easily.

In the eyeglass frame structure as shown in FIGS. 1 to 3, 6 and 8, the wind outlets 113 are provided for installing and containing a snap plate 31 disposed separately on both left and right sides of the lens 3, and the snap plates 31 lean on the partition plates 115 respectively. Therefore, the lens 3 can be installed to or moved from the frame 1 easily.

In the eyeglass frame structure as shown in FIGS. 1 to 5, 7 and 8, both left and right sides of the leeward side 19 of the frame 1 have at least one wind guide slot 114 formed at the wind outlets 113 for diffusing the wind guided by the wind outlets 113.

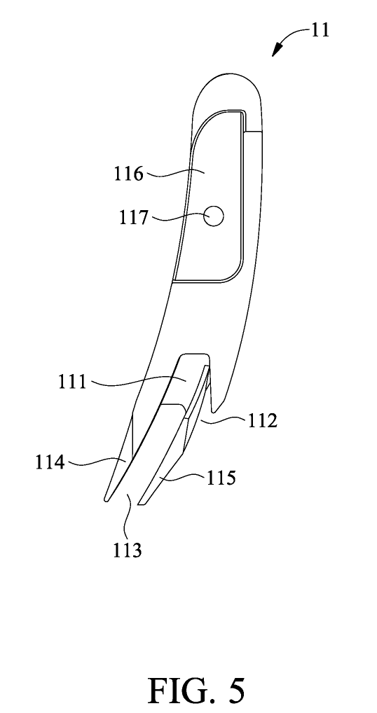

In the eyeglass frame structure as shown in FIGS. 1 to 8, each of the eyeglass arm pivoting portions 11 has a pivot slot 116 for pivotally coupling a pivot pin 21 of an eyeglass arm 2 (a pivot pin formed separately at the eyeglass arm pivoting portions 11 for pivotally coupling a pivot slot of an eyeglass arm 2). In addition, a pivot (not shown in the figure) is installed between the pivot slot 116 and the pivot pin 21 and passed through a pivot hole 117 of the pivot slot 116 and a pivot hole 211 of the pivot pin 21 to achieve the pivotal connection effect. In FIGS. 2 and 5, the pivot slot 116 of the eyeglass arm pivoting portion 11 is not interconnected to the U-shaped wind passage 111, but the pivot slot 116 of the eyeglass arm pivoting portion 11 may be concavely disposed at and interconnected to a turning position of the U-shaped wind passage 111, and then the pivot pin 21 of the eyeglass arm 2 may be extended, so that an end of the pivot pin 21 blocks the interconnected position of the pivot slot 116 and the U-shaped wind passage 111 to achieve the same wind guiding effect.

With reference to FIGS. 1 to 8 for the second preferred embodiment of eyeglasses of the present invention, the eyeglasses comprise an eyeglass frame structure, two eyeglass arms 2, two lenses 3 and two nose pads 4. Wherein, the eyeglass arms 2 are respectively and pivotally coupled to the eyeglass arm pivoting portions 11, and the lens 3 is installed to the lens connecting portion 12, wherein the lens 3 may be in any form, and made of plastic or glass, and the lens 3 may come with a parameter or a light filtering function. The nose pads 4 may be installed on a leeward side 39 of the lens 3 (or a leeward side 19 of the frame 1), and the nose pad 4 may have at least one connecting slot 41, and the leeward side 39 of the lens 3 may have at least one connecting column 33 installed in the connecting slot 41 for installing the nose pad 4 on the leeward side 39 of the lens 3. In addition, the leeward side 19 of the frame 1 may have at least one connecting column installed in the connecting slot 41 for installing the nose pad 4 on the leeward side 19 of the frame 1.

As described above, the eyeglasses of the present invention require no hole or slot formed on the lens, so that the lens structure is not damaged, and no refraction occurs at the lens. In addition, the wind passage of the eyeglasses of the present invention is substantially U-shaped for preventing tiny objects in the air from entering into the leeward side of lens directly, so as to protect the wearer's eyes from being hurt by the tiny objects. In addition, the wind outlet of the U-shaped wind passage of the eyeglasses of the present invention guides wind transversely to the leeward side of the lens, so that the wind flows smoothly through the leeward side of the lens to dissipate heat effectively and prevent the formation of mists. In addition, the eyeglasses of the present invention drives the wind to flow transversely through the leeward side of the lens and does not pass through a gap between a curved surface of a lower edge of the leeward side of the lens and a wearer's cheek bone, so as to prevent blocking or distributing the return air that causes discomfort to the wearer's eyes.

In the foregoing glasses as shown in FIGS. 1 to 3, the frame 1 is substantially U-shaped, and an outwardly convex surface of the frame 1 is the windward side 18, and an inwardly concave side of the frame 1 is the leeward side 19, and the lens connecting portion 12 may be an embedded slot formed at the lower edge of the frame 1 for embedding into the upper edge of the lens 3, and the wind outlet 113 of the eyeglass arm pivoting portions 11 is formed separately on both left and right sides of the lens 3. Therefore, the lens 3 of the present invention may be installed to the frame 1 easily, and the wind is driven to flow transversely from both left and right sides of the lens 3 through the leeward side 39 of the lens 3.

In the foregoing glasses as shown in FIGS. 2 and 7, a snap hole 13 is formed at the middle of the leeward side 19 of the frame 1 and interconnected to the lens connecting portion 12 for snapping a snap member 32 installed at the middle of the leeward side 39 of the lens 3 (or snapping a snap member installed at the middle of the leeward side 19 of the frame 1 to a snap hole formed in the lens connecting portion 12 and at the middle of the leeward side 39 of the lens 3), wherein the quantity and installation position of the snap holes 13 and the snap members 32 may be increased as required. Therefore, the lens 3 can be installed to or removed from the frame 1 easily.

In the foregoing glasses as shown in FIGS. 1 to 3, 6 to 8, the wind outlets 113 are provided for installing and containing a snap plate 31 installed separately on both left and right sides of the lens 3, and the snap plates 31 lean against the partition plates 115 respectively. Therefore, the lens 3 can be installed to or removed from the frame 1 easily.

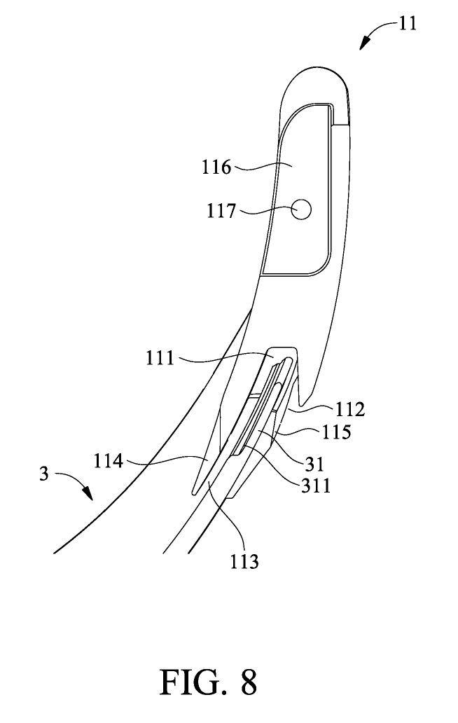

In the foregoing glasses as shown in FIGS. 1, 2 and 8, an end of each of the snap plates 31 has a thin plate section 311, so that when the snap plates 31 are installed in the wind outlets 113 respectively, the thin plate sections 311 increase the flowing area. If the ends of the snap plates 31 do not have the thin plate sections 311, and the snap plates 31 are installed into the wind outlets 113, the snap plates 31 will reduce the flowing area. In FIG. 8, the flowing area of the U-shaped wind passages 111 may be adjusted by the depth of the snap plates 31 penetrating into the U-shaped wind passages 111. The deeper the snap plates 31 penetrating into the U-shaped wind passages 111, the smaller the flowing area of the U-shaped wind passages 111, and vice versa.

In the foregoing glasses as shown in FIGS. 1 to 5, 7 and 8, both left and right sides of the leeward side 19 of the frame 1 have at least one wind guide slot 114 disposed at the wind outlets 113 for diffusing the wind guided by the wind outlets 113.

In the foregoing glasses as shown in FIGS. 1 to 8, each of the eyeglass arm pivoting portions 11 has a pivot slot 116 for pivotally coupling a pivot pin 21 of the eyeglass arm 2 (or each of the eyeglass arm pivoting portions 11 has a pivot pin for pivotally coupling a pivot slot of the eyeglass arm 2). In addition, a pivot (not shown in the figure) installed between the pivot slot 116 and the pivot pin 21 is passed through a gap between a pivot hole 117 of the pivot slot 116 and a pivot hole 211 of the pivot pin 21 to achieve the pivotal connection effect. In FIGS. 2 and 8, the pivot slot 116 of the eyeglass arm pivoting portion 11 is not interconnected to the U-shaped wind passage 111, but the pivot slot 116 of the eyeglass arm pivoting portion 11 is concavely formed at a turning position where the U-shaped wind passages 111 are interconnected, and then the pivot pin 21 of the eyeglass arm 2 is extended, so that an end of the pivot pin 21 blocks the interconnected position of the pivot slot 116 and the U-shaped wind passage 111 to achieve the wind guiding effect.

In the foregoing glasses as shown in FIGS. 1 to 3 and 7, the nose pads 4 are coupled by an elastic rod 5. Therefore, the nose pads 4 are coupled integrally and will not be missing or lost easily.

While the invention has been described by means of specific embodiments, numerous modifications and variations could be made thereto by those skilled in the art without departing from the scope and spirit of the invention set forth in the claims.

What is claimed is:

1. An eyeglass frame structure, comprising a frame, an eyeglass arm pivoting portion disposed separately on both left and right sides of the frame, a lens connecting portion disposed between the eyeglass arm pivoting portions of the frame, a U-shaped wind passage formed at each of the eyeglass arm pivoting portions and having a wind inlet formed at a windward side of the frame and a wind outlet formed at a leeward side of the frame, and the wind outlets being provided for guiding wind transversely to the leeward side of the lens, wherein the frame is substantially in U-shaped, and an outwardly convex side of the frame is the windward side, and an inwardly concave side of the frame is the leeward side.

2. The eyeglass frame structure of claim 1, wherein the lens connecting portion is an embedded slot disposed at a lower edge of the frame for embedding into an upper edge of the lens.

3. The eyeglass frame structure of claim 2, wherein the frame includes a snap hole interconnected to the lens connecting portion and provided for snapping to a snap member of the lens, or the frame includes a snap member disposed in the lens connecting portion for snapping to the snap hole of the lens.

4. The eyeglass frame structure of claim 3, wherein the wind outlets are provided for installing and containing snap plates installed on both left and right sides of the lens respectively.

5. The eyeglass frame structure of claim 1, wherein the left and right sides of the leeward side of the frame have at least one wind guide slot formed at the wind outlets.

6. The eyeglass frame structure of claim 1, wherein each of the eyeglass arm pivoting portions has a pivot slot for pivotally coupling a pivot pin of the eyeglass arm, or each of the eyeglass arm pivoting portions has a pivot pin for pivotally coupling the eyeglass arm.

7. A pair of eyeglasses, comprising; an eyeglass frame structure according to claim 1; two eyeglass arms, respectively and pivotally coupled to the eyeglass arm pivoting portions; a lens, installed at the lens connecting portion; and two nose pads, installed on the leeward side of the lens or the leeward side of the frame.

8. The eyeglasses of claim 7, wherein the frame is substantially U-shaped, and an outwardly convex side of the frame is the windward side, and an inwardly concave side of the frame is the leeward side, and the lens connecting portion is an embedded slot formed at a lower edge of the frame for embedding into an upper edge of the lens.

9. The eyeglasses of claim 8, wherein the frame includes a snap hole interconnected to the lens connecting portion for snapping a snap member to the lens, or the frame includes a snap member installed in the lens connecting portion for snapping to a snap hole of the lens.

10. The eyeglasses of claim 9, wherein the wind outlets are provided for installing and containing snap plates installed on both left and right sides of the lens respectively.

11. The eyeglasses of claim 10, wherein each of the snap plates has a thin plate section.

12. The eyeglasses of claim 7, wherein the left and right sides of the leeward side of the frame have at least one wind guide slot formed at the wind outlets.

13. The eyeglasses of claim 7, wherein each of the eyeglass arm pivoting portions has a pivot slot for pivotally coupling a pivot pin of the eyeglass arm, or each of the eyeglass arm pivoting portions has a pivot pin for pivotally coupling a pivot slot of the eyeglass arm.

14. The eyeglasses of claim 7, wherein the nose pads are coupled by an elastic rod.
